(19) United States
(12) Patent Application Publication
(10) Pub. No.: US 2026/0049543 A1
(43) Pub. Date: Feb. 19, 2026

(54) Method and Apparatus for Rock Hydraulic Fracturing under Resonant Excitation

(71) Applicants: China University of Petroleum (Beijing), Houston, TX (US); STenergy LLC, Houston, TX (US)

(72) Inventors: Ben Li, Beijing (CN); Quanjun Wang, Cypress, TX (US); Hui Li, Beijing (CN)

(21) Appl. No.: 19/271,784

(22) Filed: Jul. 17, 2025

(30) Foreign Application Priority Data
Aug. 16, 2024 (CN) 202411129255

(51) Int. Cl. E21B 43/26; E21B 43/00; E21B 49/00; G01H 13/00

(52) U.S. Cl. CPC E21B 43/26; E21B 43/003; E21B 49/006; G01H 13/00

(57) ABSTRACT

A method and apparatus for rock hydraulic fracturing under resonant excitation are disclosed. The method includes: obtaining excitation frequency and strain time-series data of a target rock sample based on a simulated pore diameter; determining the resonant frequency under the pore diameter influence; identifying the fracture initiation pressure and orientation under the resonant frequency and a preset excitation duration; and formulating a fracture induction scheme accordingly. This approach enables accurate characterization of fracture initiation conditions and improves hydraulic fracturing performance in unconventional reservoirs.

### TECHNICAL FIELD

The present invention relates to the field of unconventional oil and gas reservoir stimulation technologies, and more particularly to a method and apparatus for rock hydraulic fracturing under resonant excitation.

### BACKGROUND OF THE INVENTION

When a reservoir rock is subjected to external excitation at or near its natural frequency (resonant frequency), a resonance phenomenon occurs. Under resonant excitation, the vibration amplitude of the rock reaches a peak, and microfractures within the rock tend to initiate, propagate, and coalesce. This leads to a significant decrease in the strength of the rock, referred to as the fracture initiation pressure, indicating that resonant excitation can weaken the structural integrity of the rock. Therefore, resonant excitation is considered a promising approach to enhance the effectiveness of hydraulic fracturing in unconventional oil and gas reservoirs. Accurately determining the resonant frequency of the rock under the influence of pore diameter, as well as the fracture initiation pressure and fracture initiation orientation under the combined action of resonant frequency and excitation duration, can provide fundamental data for studying the fracture induction mechanism under resonant excitation and guide the practical application of such stimulation techniques.

However, the natural frequency of reservoir rocks and its evolution mechanism remain unclear. Existing technologies are unable to accurately determine the resonant frequency of rocks or measure the fracture initiation pressure and fracture initiation orientation under the effects of resonant excitation. As a result, studies on the fracture induction mechanism under resonant excitation lack reliable data support, leading to reduced effectiveness of hydraulic fracturing and lower development efficiency and production in unconventional oil and gas reservoirs.

To address the above issues, effective solutions have not yet been developed or reported.

### SUMMARY OF THE INVENTION

The present invention provides a method and apparatus for rock hydraulic fracturing under resonant excitation, which solves the problem that the existing technologies fail to realize accurate measurement of the resonant frequency of rocks and the fracture initiation pressure and fracture initiation orientation under resonant excitation. This enables reliable determination of the fracture induction mechanism under resonant excitation, thereby improving the effectiveness of hydraulic fracturing in unconventional oil and gas reservoirs.

In one aspect, the present invention provides a method for rock hydraulic fracturing under resonant excitation, comprising:
obtaining excitation frequency time-series data applied at a perforated end face of a target rock sample and strain time-series data from other end faces excluding the perforated end face, based on a simulated pore diameter of the target rock sample;
determining a resonant frequency of the target rock sample influenced by the simulated pore diameter from the excitation frequency time-series data based on the strain time-series data;
determining a fracture initiation pressure and a fracture initiation orientation of the target rock sample under the resonant frequency and a preset excitation duration;
formulating a fracture induction scheme based on the fracture initiation pressure and fracture initiation orientation, and performing hydraulic fracturing accordingly.

In some embodiments, the target rock sample is a rectangular specimen dried to constant weight. A simulated pore is drilled in one of its end faces, and the other five end faces are non-perforated.

In some embodiments, the simulated pore is a cylindrical through-hole with a preset diameter.

In some embodiments, the simulated pore exceeds the borehole length, and the five non-perforated end faces are each attached to a micro-resistance strain sensor.

After the target rock sample is heated to the target reservoir temperature, fracturing fluid is injected into the simulated pore at a constant pressure.

Correspondingly, excitation frequency time-series data applied at the perforated end face and strain time-series data from the remaining five non-perforated end faces of the target rock sample are obtained based on the simulated pore diameter of the target rock sample, comprising:

When the simulated pore diameter is equal to a preset pore diameter, determining whether the condition for stopping the fluid injection is met.

If so, the miniature ultrasonic vibration rod is activated to gradually increase its excitation frequency. The corresponding excitation frequency time-series data is collected, and the strain time-series data of the five non-perforated end faces is collected using micro-resistance strain sensors.

In some embodiments, determining whether the condition for stopping fluid injection is met comprises:
Acquiring the transverse relaxation time-series data of the target rock sample, which is used to determine the water saturation of the target rock sample;
Determining whether the water saturation of the target rock sample reaches a preset target value;
If so, stopping the injection of fracturing fluid at constant pressure.

In some embodiments, determining the resonant frequency of the target rock sample under the influence of the simulated pore diameter from the excitation frequency time-series data based on the strain time-series data comprises:
Calculating the average of the strain time-series data from the five non-perforated end faces;
Selecting a target average strain value greater than a preset threshold as the target average strain value;
Determining the time corresponding to the target average strain value as the resonant excitation time;
Determining the excitation frequency corresponding to the resonant excitation time from the excitation frequency time-series data as the resonant frequency of the target rock sample.

In some embodiments, the resonant frequency of the target rock sample comprises:
When the simulated pore diameter equals the preset pore diameter, the resonant frequency is defined as the resonant frequency of the target rock sample under the preset target water saturation;
When the simulated pore diameter equals the inherent pore diameter, the resonant frequency is defined as the resonant frequency of the target rock sample under the water saturation corresponding to the resonant excitation time.

In some embodiments, determining the fracture initiation pressure of the target rock sample under the resonant frequency and excitation duration comprises:
Injecting fracturing fluid into the simulated pore at a constant pressure; when the injection time reaches the preset resonant excitation time, activating the miniature ultrasonic vibration rod and adjusting its excitation frequency to match the resonant frequency of the target rock sample, and then switching the injection method from constant pressure to constant flow;
Continuing the injection of fracturing fluid at constant flow into the simulated pore until the rock sample fractures, and acquiring pump pressure time-series data;
Determining the target pump pressure data from the pump pressure time-series data as the fracture initiation pressure of the rock sample, where the target pump pressure data has a value greater than a preset threshold.

In some embodiments, determining the fracture initiation orientation of the rock sample under the resonant frequency and excitation duration comprises:
Performing CT scanning of the fractured rock sample to obtain a three-dimensional image of the target rock sample.
Performing three-dimensional reconstruction based on the three-dimensional image to obtain the fracture initiation orientation of the target rock sample according to the reconstructed result.

In a second aspect, the present invention further provides a rock hydraulic fracturing apparatus under resonant excitation, comprising:
an acquisition module, configured to obtain excitation frequency time-series data applied at a perforated end face of a target rock sample and strain time-series data from other end faces excluding the perforated end face, based on a simulated pore diameter of the target rock sample;
a resonant frequency determination module, configured to determine the resonant frequency of the target rock sample under the influence of the simulated pore diameter from the excitation frequency time-series data based on the strain time-series data;
a fracture initiation parameter determination module, configured to determine the fracture initiation pressure and fracture initiation orientation of the target rock sample under the resonant frequency and excitation duration;
a hydraulic fracturing module, configured to formulate a fracture induction scheme based on the fracture initiation parameters and to perform hydraulic fracturing based on the fracture induction scheme.

In a third aspect, the present invention further provides a computer device comprising a memory, a processor, and a computer program, wherein the processor executes the computer program to implement the method for rock hydraulic fracturing under resonant excitation as described above.

In a fourth aspect, the present invention further provides a computer-readable storage medium having stored thereon a computer program, wherein the computer program, when executed by a processor, causes the processor to implement the method for rock hydraulic fracturing under resonant excitation as described above.

In a fifth aspect, the present invention further provides a computer program product, comprising program instructions which, when executed by a processor, cause the processor to implement the method for rock hydraulic fracturing under resonant excitation as described above.

The present invention also provides a complete method and apparatus for rock hydraulic fracturing under resonant excitation. First, excitation frequency time-series data and strain time-series data of the target rock sample are obtained based on the simulated pore diameter. Then, the resonant frequency of the rock is determined. The fracture initiation pressure and orientation of the rock under the resonant frequency and excitation duration are further determined. Based on this, a fracture induction scheme is formulated. Hydraulic fracturing is then performed according to the fracture induction scheme. The present invention enables accurate determination of the resonant frequency and the corresponding fracture initiation parameters of the rock under resonant excitation, thereby allowing reliable formulation of the fracture induction scheme and enhancing the effectiveness of hydraulic fracturing in unconventional reservoirs.

### DESCRIPTION OF THE DRAWINGS

To provide a clearer understanding of the technical solution of the present invention, the following will describe the embodiments of the present invention with reference to the accompanying drawings. The drawings are only illustrative of certain embodiments and should not be construed as limiting the scope of the present invention. Those of ordinary skill in the art may make modifications based on these embodiments without departing from the essence and scope of the invention. The drawings are as follows:

FIG. 1 is a schematic flowchart of a rock hydraulic fracturing method under resonant excitation provided in one embodiment of the present invention;

FIG. 2 is a schematic diagram illustrating an application scenario of the rock hydraulic fracturing method under resonant excitation according to one embodiment of the present invention.

FIG. 3 is a schematic diagram illustrating an application scenario of the rock hydraulic fracturing method under resonant excitation according to one embodiment of the present invention.

FIG. 4 is a structural schematic diagram of a rock hydraulic fracturing apparatus under resonant excitation according to one embodiment of the present invention.

FIG. 5 is a structural schematic diagram of an electronic device according to one embodiment of the present invention.

### SPECIFIC EMBODIMENTS

To enable those skilled in the art to better understand the technical solutions of the present invention, the embodiments of the present invention are described below with reference to the accompanying drawings. It should be understood that the described embodiments are only part of the embodiments of the present invention, not all possible embodiments. Based on the embodiments described herein, all other implementations obtained by a person of ordinary skill in the art without creative effort shall fall within the scope of protection of the present invention.

Reservoir rocks are composed of rock particles, pores, and microfractures, forming a complex medium. Their mechanical properties are significantly affected by temperature, fluid pressure, and surrounding environmental conditions. When subjected to external excitation at or near their natural frequency (resonant frequency), a resonance phenomenon occurs in the rock. At this stage, internal microfractures are prone to initiate and propagate, leading to a reduction in rock strength. That is, resonant excitation has a weakening effect on rock strength. This effect is more pronounced when the excitation frequency closely matches the inherent frequency of the rock. The internal part of the rock then exhibits a relatively high vibration amplitude within a short period of time, which intensifies the propagation of existing damage or accelerates the development of new damage, further reducing rock strength. Therefore, resonant excitation is a promising approach to enhance the effectiveness of hydraulic fracturing in unconventional oil and gas reservoirs. Accurately determining the resonant frequency of the rock influenced by the pore diameter, and further determining the fracture initiation pressure and orientation under resonant frequency and excitation duration, can provide fundamental data for studying the fracture induction mechanism under resonant excitation, and thereby improve the production of unconventional oil and gas.

However, the natural frequency of rocks and its evolution mechanism are still not well understood. Existing technologies are unable to accurately measure the resonant frequency of rocks or the fracture initiation pressure and fracture orientation under resonant excitation. As a result, the fracture induction mechanism under resonant excitation lacks reliable data support, leading to poor fracturing efficiency, low stimulation effectiveness, and limited recovery in unconventional reservoirs.

In view of the above problems, and in order to overcome the specific limitations described above, the present application proposes a complete method and apparatus for rock hydraulic fracturing under resonant excitation. By determining the fracture initiation pressure and orientation of the rock under resonant frequency and excitation duration, the invention enables accurate formulation of a fracture induction scheme, thereby significantly improving fracturing effectiveness in unconventional oil and gas reservoirs.

The method for rock hydraulic fracturing under resonant excitation comprises the following steps. First, excitation frequency time-series data applied at the perforated end face of a target rock sample and strain time-series data from the five non-perforated end faces are obtained based on the simulated pore diameter. Then, based on the strain time-series data, the resonant frequency of the rock sample under the influence of pore diameter is determined. Further, the fracture initiation pressure and fracture initiation orientation under the resonant frequency and excitation duration are determined. Based on this, a fracture induction scheme is formulated, and hydraulic fracturing is performed accordingly based on the scheme.

FIG. 1 is a flowchart illustrating a rock hydraulic fracturing method under resonant excitation according to one embodiment of the present invention.

Although the present invention provides the method steps or module structure as shown in or described with reference to the embodiments and figures, those of ordinary skill in the art will understand that, based on conventional knowledge and without inventive effort, such methods or devices may also include more or fewer steps or modules, which fall within the scope of the invention.

Step S101: Obtaining excitation frequency time-series data applied at a perforated end face of a target rock sample and strain time-series data from other end faces excluding the perforated end face, based on the simulated pore diameter of the target rock sample.

In some embodiments, the target rock sample in S101 is a rectangular specimen dried to constant weight. The simulated pore is drilled at one of the end faces, and the remaining five end faces are non-perforated.

Additionally, before S101, the method may further comprise:
Step S11: Arranging a miniature ultrasonic vibration rod at the perforated end face of the target rock sample and arranging micro-resistance strain sensors respectively on the five non-perforated end faces.
Step S12: Heating the target rock sample to the target temperature and injecting fracturing fluid into the simulated pore at constant pressure.

Correspondingly, excitation frequency and strain time-series data from the end faces of the heated sample are acquired as described in S101.
Step S13: When the simulated pore diameter of the target rock sample reaches a preset value, determining whether the condition for stopping fluid injection is met.
Step S14: If so, gradually increasing the excitation frequency of the miniature ultrasonic vibration rod to acquire excitation frequency time-series data and simultaneously obtaining strain time-series data from the five non-perforated end faces using the micro-resistance strain sensors.

In some embodiments, the determination of whether the condition for stopping injection in S13 is satisfied may comprise:
Acquiring transverse relaxation time-series data of the target rock sample, and using the transverse relaxation data to determine water saturation;
Step S132: Determining whether the water saturation reaches a preset target value;
Step S133: If yes, stopping the injection of fracturing fluid at constant pressure.

In some embodiments, the target rock sample may also be a simulated core sample subjected to perforation. The perforation is aligned axially, and the ultrasonic energy is transmitted axially. Among the six end faces, one is perforated and the remaining five are non-perforated. The strain sensors are attached to the five non-perforated faces, forming a complete test configuration.

The target rock sample may be a rectangular specimen dried to constant weight at a certain temperature, such as 60° C. The specimen may have a length and width of approximately 8 cm and a height of approximately 10 cm. The sample comprises six end faces, one of which may be a perforated end face with a width of approximately 8 cm and a square shape. The remaining five faces are non-perforated, and a simulated pore may be drilled at the center of the perforated end face.

The diameter of the simulated pore may be a preset value, such as d mm, which can be configured based on actual requirements. The invention places no specific limitation on this value. The length of the simulated pore may be, for instance, 4 cm, and a casing pipe made of steel or similar material may be inserted. The assembled simulated wellbore is then sealed and dried with the specimen at 60° C.

When the preset diameter of the simulated pore is, for instance, 10 mm, and the pore length is 4 cm, a steel casing pipe with an outer diameter of 10 mm and length of 3 cm may be inserted. The assembled simulated wellbore is sealed and dried together with the specimen to obtain the target sample.

In some embodiments, a miniature ultrasonic vibration rod may be installed at the perforated end face, and micro-resistance strain sensors are attached to the five non-perforated end faces. After the target rock sample is heated to the test temperature, fracturing fluid is injected into the simulated pore at constant pressure. Injection time and temperature are adjusted according to experimental requirements, and ultrasonic excitation is applied after saturation to simulate resonant excitation and observe fracture propagation.

When the simulated pore diameter of the target rock sample is equal to a preset pore diameter, it is determined whether the condition for stopping the injection of fracturing fluid has been satisfied. If the condition is satisfied, the miniature ultrasonic vibration rod is activated, and its excitation frequency ƒ is gradually increased. The excitation frequency time-series data ƒ(t) is recorded or acquired. Meanwhile, micro-resistance strain sensors are used to measure or obtain the strain time-series data εᵢ(t) from the five non-perforated end faces of the rock sample, where i=1, 2, 3, 4, 5. If the condition for stopping fluid injection is not yet satisfied, the injection of fracturing fluid at constant pressure continues until the stopping condition is met.

In some embodiments, the condition for stopping the injection of fracturing fluid is determined based on whether the water saturation Sw(t) of the target rock sample has reached a preset target water saturation Sw_{target}. If the water saturation Sw(t) reaches the preset target water saturation Sw_{target}, the condition for stopping injection is considered satisfied. If the water saturation Sw(t) has not reached the preset target value, the condition is considered not satisfied. Specifically, a target water saturation Sw_{target} may be preset according to actual requirements, without limitation imposed by this specification. Nuclear Magnetic Resonance (NMR) may then be used to measure the transverse relaxation time-series data T₂ (t) of the target rock sample. Based on the obtained T₂ (t) data, the water saturation Sw(t) of the rock sample is calculated. Finally, it is determined whether Sw(t) is equal to or has reached Sw_{target}. If so, the injection of fracturing fluid at constant pressure is stopped.

The transverse relaxation time T₂(t) reflects the relaxation characteristics of fluids within the rock pores, such as water, oil, or gas, and is closely related to the pore structure of the rock, the fluid type, and the saturation level. By measuring and analyzing the distribution of T₂(t), the water saturation of the rock sample can be inferred indirectly. The T₂ (t) distribution of rocks is typically obtained through Nuclear Magnetic Resonance (NMR) logging or laboratory-based NMR measurements. Variations in fluid types and pore sizes lead to different T₂ (t) values. For instance, water tends to exhibit shorter T₂ (t) values, whereas oil and gas may exhibit longer T₂ (t) values. However, the specific relaxation time is also influenced by the geometric structure and connectivity of the pores.

In some embodiments, the operation in step S101 of obtaining excitation frequency time-series data applied at the perforated end face of a target rock sample and strain time-series data from the other end faces excluding the perforated end face, based on the simulated pore diameter of the target rock sample, may further comprise the following in specific implementations:

When the simulated pore diameter of the target rock sample corresponds to the inherent pore diameter (for example, 10 mm), the miniature ultrasonic vibration rod is activated, and its excitation frequency ƒ is gradually increased. The excitation frequency time-series data ƒ(t) is acquired, and the strain time-series data εᵢ(t) from the five non-perforated end faces is obtained using micro-resistance strain sensors, where i=1, 2, 3, 4, 5.

By obtaining excitation frequency time-series data applied at the perforated end face of the target rock sample and strain time-series data from the other end faces excluding the perforated end face, based on the simulated pore diameter of the target rock sample, a foundation is established for accurately determining or measuring the resonant frequency of the target rock sample under the influence of the pore (simulated pore) diameter.

S102: Determining the resonant frequency of the target rock sample under the influence of the simulated pore diameter from the excitation frequency time-series data based on the strain time-series data.

In some embodiments, the operation in step S102 of determining the resonant frequency of the target rock sample under the influence of the simulated pore diameter from the excitation frequency time-series data based on the strain time-series data may comprise:
S21: Calculating the average value of the strain time-series data from the five non-perforated end faces;
S22: Selecting a target average strain value from the computed average values, wherein the target average strain value is greater than a preset threshold;
S23: Determining the time corresponding to the target average strain value as the resonant excitation time;
S24: Determining the excitation frequency corresponding to the resonant excitation time from the excitation frequency time-series data as the resonant frequency of the target rock sample.

In some embodiments, the resonant frequency of the target rock sample in step S24 may comprise:
When the simulated pore diameter of the target rock sample is a preset pore diameter, the resonant frequency is defined as the resonant frequency of the target rock sample under the preset target water saturation;
When the simulated pore diameter of the target rock sample is the inherent pore diameter, determining the water saturation of the target rock sample corresponding to the resonant excitation time, and accordingly defining the resonant frequency as the resonant frequency of the target rock sample under the corresponding water saturation.

In some embodiments, the average strain value ε(t) of the strain time-series data εᵢ(t) from the five non-perforated end faces (where i=1,2,3,4,5) may be calculated or determined. A target average strain value may then be selected from the average strain data ε(t), for example, by comparing ε(t) with a preset average threshold. Based on the comparison result, the target average strain value is selected such that it is greater than the preset threshold. The preset threshold may be defined according to actual requirements, and this specification imposes no specific limitation on it. The maximum value of the average strain data εₘₐₓ(t_{sym}) is then identified as the target strain value, and the time t_{sym} corresponding to εₘₐₓ(t_{sym}) is determined as the resonant excitation time. Subsequently, the excitation frequency corresponding to t_{sym} is determined from the excitation frequency time-series data ƒ(t). This frequency ƒ(t_{sym}) is defined as the resonant frequency of the target rock sample. When the simulated pore diameter of the target rock sample is a preset pore diameter (dmm), the resonant frequency ƒ(t_{sym}) is defined as the resonant frequency of the target rock sample under the preset target water saturation Sw_{target} (also referred to as a fixed frequency). When the simulated pore diameter corresponds to the inherent pore diameter (for example, 10 mm), the target water saturation Sw(t_{sym}) of the target rock sample corresponding to the resonant excitation time t_{sym} is determined. The resonant frequency ƒ(t_{sym}) is then defined as the resonant frequency of the target rock sample under the water saturation Sw(t_{sym}) (or fixed frequency).

By determining whether the simulated pore diameter of the target rock sample is a preset pore diameter or an inherent pore diameter and accordingly defining the resonant frequency of the target rock sample, the resonant frequency of the target rock sample under different water saturation levels (liquid-phase saturation) and pore diameters can be accurately determined. This provides a foundation for the subsequent accurate measurement of key parameters such as fracture initiation pressure and fracture initiation orientation under the action of the resonant frequency and resonant excitation duration.

In some embodiments, when the simulated pore drilled at the perforated end face of the target rock sample has a diameter of 10 mm and a length of 4 cm, the target rock sample may be heated to a target temperature, and fracturing fluid may be injected into the simulated pore at constant pressure. Thereafter, the miniature ultrasonic vibration rod is activated, and its excitation frequency ƒ is gradually increased. The excitation frequency time-series data ƒ(t) is recorded or acquired. At the same time, Nuclear Magnetic Resonance (NMR) equipment is used to measure the transverse relaxation time-series data T₂(t) of the target rock sample. Based on the transverse relaxation data T₂(t), the water saturation Sw(t) of the rock sample is calculated. Micro-resistance strain sensors are used to measure or acquire strain time-series data εᵢ(t) from the five non-perforated end faces, where i=1,2,3,4,5. The average value ε(t) of the strain time-series data from the five non-perforated end faces is then calculated or determined. The maximum value of the average strain εₘₐₓ(t_{sym}) is identified, and the water saturation Sw(t_{sym}) and the excitation frequency ƒ(t_{sym}) corresponding to t_{sym} are determined. The excitation frequency ƒ(t_{sym}) is then defined as the resonant frequency (or fixed frequency) of the target rock sample under the water saturation Sw(t_{sym}).

In some embodiments, the resonant frequency of the target rock sample in step S24 may be specifically determined using the following equation:

$${ϵ}_{{t}_{sym}} ( {t}_{sym} ) = 0.2 max ( {\sum }_{i = 1}^{5} {ϵ}_{i} ( t ) ) \qquad ( 1 )$$

$${f}_{sym} = f ( {t}_{sym} ) \qquad ( 2 )$$

Where t_{sym} denotes the resonant excitation time; εₜ_{_{sym}} refers to the strain value at resonance (that is, the average value of the target strain time-series data mentioned above); max represents the maximum operator;

$${\sum }_{i = 1}^{5} {ϵ}_{i} ( t )$$

indicates the sum of the strain time-series data from the five non-perforated end faces; ε(t) refers to the strain time-series data from the i-th non-perforated end face, representing the variation of strain with respect to time t; ƒ_{sym} is the resonant frequency of the target rock sample; and ƒ(t_{sym}) is the excitation frequency corresponding to the resonant excitation time t_{sym}.

In some embodiments, the resonant frequency of the target rock sample under the target water saturation may be determined using the following equation:

$$Sw ( {t}_{sym} ) = \frac{{\int }_{min ( T 2 )}^{max ( T 2 )} {A}_{sw} ( {t}_{sym} ) dT 2}{{\int }_{min ( T 2 )}^{max ( T 2 )} {A}_{swsat} dT 2} f ( {t}_{sym} ) \qquad ( 3 )$$

$${f}_{res} ( {s}_{w} ) = f ( {t}_{sym} ) \qquad ( 4 )$$

Where Sw(t_{sym}) is the target water saturation of the target rock sample corresponding to the resonant excitation time t_{sym}; T₂ is the transverse relaxation time; max represents the maximum operator; A_{sw}(t_{sym}) is the Nuclear Magnetic Resonance (NMR) signal amplitude at the resonant excitation time t_{sym}; A_{swsat} is the NMR signal amplitude under fully water-saturated conditions; ƒᵣₑₛ (s_{w}) denotes the resonant frequency under the target water saturation Sw(t_{sym}); and ƒ(t_{sym}) is the excitation frequency corresponding to the resonant excitation time t_{sym}.

In some embodiments, the water saturation Sw(t) of the target rock sample may also be calculated based on the transverse relaxation time-series data T₂ (t) using the above Equation (3), by substituting Sw(t_{sym}) in Equation (3) with Sw(t) and T₂ with T₂(t).

S103: Determining the fracture initiation pressure and fracture initiation orientation of the target rock sample under the resonant frequency and a preset resonant excitation duration.

In some embodiments, the operation in step S103 of determining the fracture initiation pressure of the target rock sample under the resonant frequency and the preset resonant excitation duration may comprise:
S31: Injecting fracturing fluid at constant pressure into the simulated pore at the perforated end face of the target rock sample; when the injection duration reaches the preset resonant excitation duration, activating the miniature ultrasonic vibration rod, adjusting its excitation frequency to the resonant frequency of the target rock sample, and switching from constant pressure injection to constant flow rate injection;
S32: Continuing to inject fracturing fluid at a constant flow rate into the simulated pore at the perforated end face of the target rock sample until the rock sample fractures, and acquiring the injection pressure time-series data;
S33: Determining the target injection pressure time-series data from the acquired pressure data as the fracture initiation pressure of the target rock sample, wherein the pressure value of the target injection pressure time-series data is greater than a preset pressure threshold.

In some embodiments, a preset rock sample temperature T_{target} and a preset resonant excitation duration t_{sym-target} may first be defined. Subsequently, the fracture initiation pressure and fracture initiation orientation under the combined conditions of the preset temperature, preset resonant excitation duration (at which the target rock sample reaches the preset target water saturation), and the resonant frequency described above may be determined. The fracture initiation orientation will be explained separately in subsequent sections and is not further detailed herein. The preset rock sample temperature T_{target} and preset resonant excitation duration t_{sym-target} may be determined according to practical needs, and this specification does not impose specific limitations in this regard.

Specifically, when the target rock sample is heated to the preset temperature T_{target}, fracturing fluid is injected into the simulated pore on the perforated end face of the sample under constant pressure. When the injection duration reaches the preset resonant excitation duration t_{sym-target}, the miniature ultrasonic vibration rod is activated, and its excitation frequency is adjusted to the resonant frequency ƒ(t_{sym}) of the target rock sample. The injection mode is then switched from constant pressure to constant flow. Fracturing fluid is then injected into the simulated pore under constant flow until the target rock sample fractures. The injection pressure time-series data P(t) is recorded or acquired. The target injection pressure data is determined by comparing P(t) with a preset pressure threshold; the maximum pressure value Pₘₐₓ(t), which exceeds the threshold, is taken as the fracture initiation pressure of the target rock sample. The preset pressure threshold may also be defined according to actual requirements, and this specification does not limit it specifically.

By switching from a constant-pressure injection mode to a constant-flow injection mode, the fracturing process can be more effectively controlled, ensuring a stable flow rate of the fracturing fluid, which in turn better regulates fracture development and propagation. In fracturing operations, the injection mode of the fracturing fluid significantly influences the initiation and growth of fractures. While the traditional constant-pressure mode is simple and convenient, it lacks the precision needed to control fracture geometry and direction. In contrast, the constant-flow mode, by maintaining a steady flow rate, enables better management of the fracture propagation process and avoids irregular fracture development caused by pressure fluctuations. Under constant-flow injection, the injection pressure time-series data P(t) can be used to monitor fracture initiation and growth in real time.

In some embodiments, the operation in step S103 of determining the fracture initiation orientation of the target rock sample under the resonant frequency and the preset resonant excitation duration may comprise:
S34: After the target rock sample fractures, performing CT scanning on the fractured sample to obtain a three-dimensional image of the target rock sample;
S35: Performing three-dimensional reconstruction based on the three-dimensional image and determining the fracture initiation orientation of the target rock sample based on the reconstruction results.

In some embodiments, after the target rock sample fractures, CT scanning may be performed on the fractured sample to obtain internal structural information of the rock. A high-resolution three-dimensional image is obtained, which may reveal the distribution and morphology of fractures as well as their spatial relation to the wellbore end face. The three-dimensional image is then reconstructed to further analyze the geometric characteristics of the fracture, which may include the angle α between the fracture and the plane perpendicular to the wellbore end face, and the angle β between the fracture and the plane parallel to the wellbore end face. These angles represent the fracture initiation orientation of the target rock sample (hydraulic fracture).

By setting the preset rock sample temperature and the preset resonant excitation duration, the fracture initiation pressure and fracture initiation orientation under the combined influence of the preset rock sample temperature, preset resonant excitation duration, and the resonant frequency of the target rock sample can be accurately and comprehensively determined. This provides a solid experimental or data foundation for subsequent studies on the fracture induction mechanism under resonant excitation.

S104: Based on the determined fracture initiation pressure and fracture initiation orientation, developing a fracture induction scheme under resonant excitation, such that hydraulic fracturing is carried out in accordance with the fracture induction scheme.

In some embodiments, the resonant excitation refers to external excitation applied to the target rock sample that corresponds to its natural frequency (resonant frequency).

In some embodiments, after the resonant frequency of the target rock sample influenced by the pore diameter is determined, resonant excitation may be applied to the sample. This resonant excitation may reduce the fracture initiation pressure and adjust the fracture initiation orientation, thereby resulting in more complex fractures and improving the production of unconventional oil and gas.

In some embodiments, a fracture induction scheme under resonant excitation may be developed based on the determined fracture initiation pressure and fracture initiation orientation, and hydraulic fracturing may be performed based on the fracture induction scheme to enhance the effectiveness of hydraulic fracturing in unconventional reservoirs, thereby improving the production and efficiency of unconventional oil and gas.

The various embodiments in this specification are described in a progressive manner, and similar or identical features among the embodiments can be referenced mutually. Each embodiment focuses on the differences relative to the others. Specific implementation details may be referred to in the descriptions of related embodiments above and are not repeated here.

The foregoing description serves to illustrate the present application. It should be noted that the specific embodiments described herein are intended solely to facilitate understanding of the invention and are not to be construed as limiting. Other embodiments are within the scope defined by the appended claims. In certain cases, the actions or steps recited in the claims may be executed in a sequence different from that described in the embodiments and still achieve the desired results. Furthermore, the processes illustrated in the figures do not necessarily require the specific or sequential order shown to achieve the intended effects. In some embodiments, multitasking and parallel processing may also be possible or even advantageous.

The following description provides a specific example to illustrate the above method. However, it should be noted that this example is intended solely to aid in understanding and shall not be construed as an undue limitation of the present application.

Prior to the specific implementation, a rectangular rock sample with side lengths of 8 cm, 8 cm, and 10 cm is prepared. A simulated pore with an inherent diameter of 10 mm or a preset diameter d mm and a depth of 4 cm is drilled at the center of one 8 cm×8 cm end face. When the simulated pore has a preset diameter, a simulated wellbore made of steel having the same wall thickness and grade as a casing pipe is fabricated with a length of 3 cm and an outer diameter of d mm. This simulated wellbore is consolidated into the simulated pore, and the rock sample is then dried at 60° C. until a constant weight is achieved to obtain the target rock sample. When the simulated pore has the inherent diameter, the simulated wellbore is made with a length of 3 cm and an outer diameter of 10 mm using the same steel specification and similarly consolidated and dried to constant weight. The target rock sample has six end faces, including one perforated end face and five non-perforated end faces. A miniature ultrasonic vibration rod is arranged on the perforated end face, and one micro-resistance strain sensor is arranged on each of the five non-perforated end faces.

In implementation, after heating the target rock sample to the rock temperature, fracturing fluid is injected into the simulated pore at constant pressure. When the simulated pore has a preset diameter, it is determined whether the condition to stop injecting fracturing fluid is met. If so, the miniature ultrasonic vibration rod is activated, and its excitation frequency is gradually increased to collect the time-series data of the excitation frequency. Meanwhile, the strain time-series data from the five non-perforated end faces is collected using the micro-resistance strain sensors. When the simulated pore has the inherent diameter, the same procedure is followed without the need to assess the injection stop condition. The average value of the strain time-series data is calculated from the five non-perforated end faces. The maximum value of the average strain data is then identified, and the time corresponding to that maximum is determined as the resonant excitation time. The excitation frequency at that time is defined as the resonant frequency of the target rock sample. When the simulated pore has a preset diameter, the resonant frequency is defined as the resonant frequency (or fixed frequency) at the preset target water saturation. When the simulated pore has the inherent diameter, the water saturation corresponding to the resonant excitation time is determined, and the resonant frequency is defined as the frequency at that water saturation. Subsequently, the fracture initiation pressure and fracture initiation orientation are determined under the resonant frequency and preset resonant excitation time. A fracture induction scheme is then developed based on these values, and hydraulic fracturing is carried out accordingly.

The above method enables accurate measurement of key parameters such as the fracture initiation pressure and fracture initiation orientation under the intrinsic frequency and resonant excitation duration of the rock sample. This provides an experimental foundation for investigating the fracture induction mechanism under resonant excitation and thereby enhances the effectiveness of hydraulic fracturing in unconventional oil and gas reservoirs.

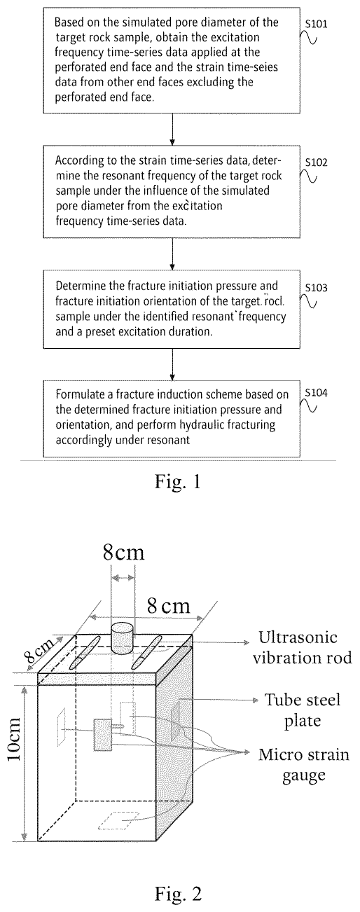

In a specific implementation scenario, the procedure for determining the resonant frequency of a rock sample under the influence of liquid-phase saturation and pore diameter is as follows (in this case, the simulated pore has a fixed diameter of 10 mm):
(1) Referring to FIG. 2, a rectangular rock sample with a length and width of 8 cm and a height of 10 cm is prepared. A simulated pore with a diameter of 10 mm and a depth of 4 cm is drilled at the center of the 8 cm×8 cm square end face of the rock sample.
(2) A simulated wellbore (simulated casing segment) is fabricated from steel with the same wall thickness and grade as a casing pipe. The wellbore has a length of 3 cm and an outer diameter of 10 mm. The simulated wellbore is consolidated into the simulated pore, and the rock sample is subsequently dried at 60° C. until a constant weight is achieved.
(3) Referring to FIG. 2, micro-resistance strain sensors are arranged on the other five non-perforated end faces of the rock sample. A miniature ultrasonic vibration rod is arranged on the perforated end face. Triaxial stress is applied to all six end faces of the rock sample. After heating the sample to the reservoir temperature during fracturing, fracturing fluid is injected at a constant pressure into the simulated pore. It is ensured that the temperature of the injected fracturing fluid and the rock sample matches that of the fracturing fluid and formation rock at the corresponding reservoir depth.
(4) Activate the miniature ultrasonic vibration rod, gradually increase the excitation frequency ƒ of the rod, and record the time-sequence data of the excitation frequency ƒ(t). Simultaneously, measure the transverse relaxation time sequence data T₂ (t) of the rock sample using a nuclear magnetic resonance (NMR) device, and measure the strain time-sequence data εᵢ(t) (where i=1,2,3,4,5) of the five non-perforated end faces of the rock sample using micro-resistance strain gauges.
(5) Calculate the water saturation Sw(t) of the target rock sample based on the transverse relaxation time-sequence data T₂(t). Then calculate the average strain value ε(t) of the strain time-sequence data εᵢ(t) (where i=1,2,3,4,5) obtained from the five non-perforated end faces. Determine the maximum value εₘₐ(t_{sym}) of ε(t), and identify the water saturation Sw(t_{sym}) and the excitation frequency ƒ(t_{sym}) corresponding to the time t_{sym}. The excitation frequency ƒ(t_{sym}) can then be considered the resonant frequency (or fixed frequency) of the target rock sample under the water saturation Sw(t_{sym}).

The procedure for determining the resonant frequency of a rock sample under the influence of liquid-phase saturation and pore diameter (where the simulated pore diameter is dmm and the target water saturation Sw_{target} is preset according to actual requirements, enabling measurement under various saturation and pore diameter conditions) includes:
(1) Referring to FIG. 2, a rectangular rock sample with a length and width of 8 cm and a height of 10 cm is prepared. A simulated pore with a diameter of dmm and a depth of 4 cm is drilled at the center of the 8 cm×8 cm square end face of the sample.
(2) A simulated wellbore is fabricated from steel with the same wall thickness and grade as that of casing pipe. The wellbore has a length of 3 cm and an outer diameter of dmm. It is fixed into the simulated pore, and the rock sample is dried at 60° C. until constant weight is achieved.
(3) Referring to FIG. 2, micro-resistance strain sensors are arranged on the five non-perforated end faces of the rock sample. A miniature ultrasonic vibration rod is arranged on the perforated end face. Triaxial stress is applied to all six end faces of the rock. After the sample is heated to the reservoir temperature for fracturing, fracturing fluid is injected at constant pressure into the simulated pore. The temperature of the injected fracturing fluid and the rock sample is ensured to match the temperature at the corresponding reservoir depth.
(4) The target water saturation Sw_{target} is preset. The transverse relaxation time-sequence data T₂(t) of the rock sample is measured using the NMR device. Based on T₂(t), the water saturation Sw(t) of the target rock sample is calculated. Once Sw(t)=Sw_{target}, the injection of fracturing fluid at constant pressure is stopped.
(5) The miniature ultrasonic vibration rod is activated, and the excitation frequency ƒ is gradually increased. The time-sequence data ƒ(t) is recorded. Simultaneously, the transverse relaxation time-sequence data T₂ (t) and the strain time-sequence data ε_{g}(t) (where i=1,2,3,4,5) from the five non-perforated end faces are measured using the NMR device and micro-resistance strain gauges.
(6) Based on the strain time-sequence data εᵢ(t), calculate the average strain ε(t), and determine its maximum value εₘₐₓ(t_{sym}). Identify the excitation frequency ƒ(t_{sym})) corresponding to the time t_{sym}. The excitation frequency ƒ(t_{sym}) is considered the resonant frequency (or fixed frequency) of the rock sample (with pore diameter dmm)under the target water saturation Sw_{target}.

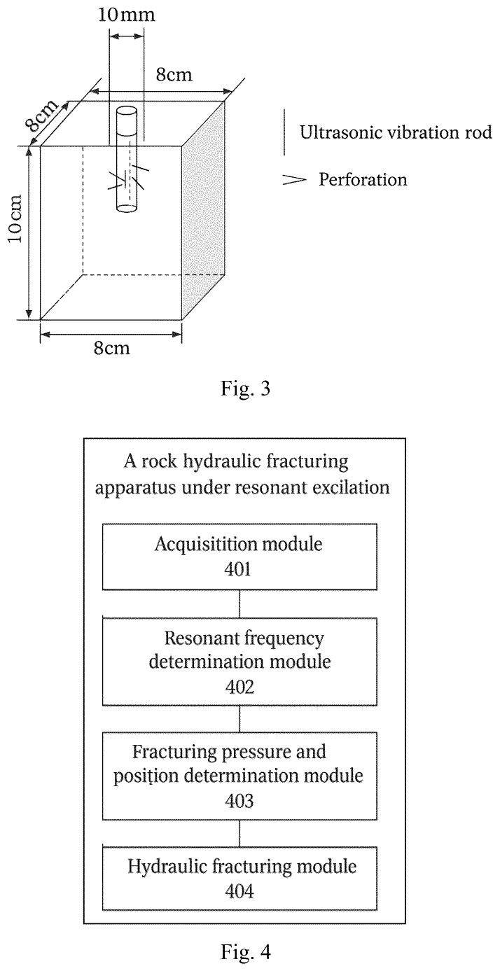

The procedure for determining the fracture initiation pressure and fracture initiation orientation under the effects of a preset fluid pre-saturation time, preset rock sample temperature, preset resonant excitation duration, and resonant frequency includes:
(1) Referring to FIG. 3, prepare a rectangular rock sample with a length and width of 8 cm and a height of 10 cm. Drill a simulated wellbore with a diameter of 10 mm and a depth of 6 cm at the center of the 8 cm×8 cm end face.
(2) Fabricate a simulated wellbore using steel material with the same wall thickness and grade as that of a cementing casing, with a length of 6 cm and an outer diameter of dmm. Consolidate the simulated wellbore into the drilled hole, and then dry the rock sample at 60° C. until constant weight is reached.
(3) Drill simulated perforation holes in a helical perforation configuration at a 120-degree phase angle within the simulated wellbore, as shown in FIG. 3.
(4) Referring to FIG. 3, uniformly place three miniature ultrasonic vibration rods along the inner wall of the simulated wellbore. Apply triaxial stress to all six end faces of the rock sample.
(5) Set a preset rock sample temperature T_{target} and a preset resonant excitation duration t_{sym-target}. After heating the rock sample to T_{target}, inject fracturing fluid into the wellbore at a constant pressure. When the injection time reaches t_{sym-target}, activate the miniature ultrasonic vibration rod, adjust the excitation frequency to the resonant frequency ƒ(t_{sym}) of the rock sample, and switch the injection mode of the fracturing fluid from constant pressure to constant flow.
(6) Switch the fracturing fluid injection mode from constant pressure to constant flow, and record the pump pressure time series data P(t) until the rock sample fractures. Determine the maximum value of P(t), denoted as Pₘₐₓ(t), which is taken as the fracture initiation pressure.
(7) After the experiment, perform a CT scan of the fractured rock sample and conduct three-dimensional reconstruction to obtain the angle α between the fracture and the vertical wellbore end face, as well as the angle β between the fracture and the plane parallel to the wellbore end face, thereby determining the fracture initiation orientation.

Although this specification provides the procedural steps of the method or the structural modules of the device as illustrated in the following embodiments or in FIG. 4, additional or fewer procedural steps or functional modules may be incorporated in the method or device through routine or non-inventive modifications. For steps or structures that are not logically causally dependent, the execution order of the steps or the module configuration of the device is not limited to the sequence or structure described in the embodiments or shown in the figures. When implemented in practical devices, servers, or terminal products, the method or structural modules may be executed sequentially as described in the embodiments or figures, or in parallel (for example, in multi-threaded processing environments, parallel processors, or distributed systems including server clusters). Based on the above-described method for hydraulic fracturing of rock under resonant excitation, this specification also provides an embodiment of a device for hydraulic fracturing of rock under resonant excitation. As shown in FIG. 4, the device may specifically include the following modules:
An acquisition module 401, configured to acquire excitation frequency time series data applied at the perforated end face of the target rock sample and strain time series data at the remaining non-perforated end faces, based on the simulated pore diameter of the target rock sample;
A resonant frequency determination module 402, configured to determine the resonant frequency of the target rock sample under the influence of the simulated pore diameter, based on the strain time series data and the excitation frequency time series data;
A fracture initiation pressure and orientation determination module 403, configured to determine the fracture initiation pressure and fracture initiation orientation of the target rock sample under the determined resonant frequency and a preset resonant excitation duration;
A hydraulic fracturing module 404, configured to develop a fracture induction scheme under resonant excitation based on the fracture initiation pressure and fracture initiation orientation, and to perform hydraulic fracturing according to the fracture induction scheme.

In some embodiments, the target rock sample in the acquisition module 401 is a rectangular rock sample dried to a constant weight, in which one perforated end face is drilled with a simulated borehole, and the remaining end faces other than the perforated end face include five non-perforated end faces. Accordingly, prior to the operation of the acquisition module 401, it may further be configured to arrange a miniature ultrasonic vibration rod at the perforated end face of the target rock sample, and to arrange corresponding micro-resistance strain sensors on the five non-perforated end faces, respectively. After heating the target rock sample to a specified sample temperature, fracturing fluid is injected into the simulated borehole under constant pressure. Correspondingly, the acquisition module 401 may be specifically configured to determine whether a condition for stopping the injection of fracturing fluid is met when the simulated borehole diameter of the target rock sample is the preset borehole diameter. If the condition is met, the miniature ultrasonic vibration rod is activated and its excitation frequency is gradually increased, while excitation frequency time series data is acquired, and the strain time series data of the five non-perforated end faces is obtained using the micro-resistance strain sensors.

In some embodiments, the acquisition module 401 may also be configured to acquire the transverse relaxation time series data of the target rock sample, which is used to determine the water saturation of the target rock sample; and to determine whether the water saturation of the target rock sample reaches a preset target water saturation. If so, the injection of fracturing fluid under constant pressure is stopped.

In some embodiments, the resonant frequency determination module 402 may be specifically configured to determine the average value of the strain time series data from the five non-perforated end faces; to select, from the average strain time series data, a target average value that exceeds a preset average threshold; to determine the time corresponding to the target average value as the resonant excitation time; and to determine the excitation frequency corresponding to the resonant excitation time from the excitation frequency time series data as the resonant frequency of the target rock sample.

In some embodiments, the resonant frequency determination module 402 may also be configured such that, when the simulated borehole diameter of the target rock sample is the preset borehole diameter, the resonant frequency of the target rock sample is its resonant frequency under the preset target water saturation; and when the simulated borehole diameter is the inherent borehole diameter, the water saturation of the target rock sample at the resonant excitation time is determined, and the corresponding resonant frequency is taken as the resonant frequency of the rock sample under that water saturation.

In some embodiments, the fracture initiation pressure and orientation determination module 403 may be specifically configured to inject fracturing fluid into the simulated borehole at the perforated end face of the target rock sample under constant pressure, activate the miniature ultrasonic vibration rod and adjust its excitation frequency to the resonant frequency of the target rock sample when the injection duration reaches the preset resonant excitation time, and switch from constant pressure to constant flow injection; to continue injecting the fracturing fluid under constant flow until the target rock sample fractures, and to acquire pumping pressure time series data; and to determine the target pumping pressure time series data from the acquired data as the fracture initiation pressure of the target rock sample, where the pressure value of the target pumping pressure time series exceeds a preset pressure threshold.

In some embodiments, the fracture initiation pressure and orientation determination module 403 may also be configured to perform CT scanning on the fractured target rock sample after failure to obtain a three-dimensional image of the sample, and to perform three-dimensional reconstruction on the image in order to determine the fracture initiation orientation based on the reconstructed results.

As evident from the above, the hydraulic fracturing device for rock under resonant excitation provided in the embodiments of the present disclosure can achieve precise measurement of the fracture initiation pressure and orientation under the action of the resonant frequency and resonant excitation time, thereby providing an experimental foundation for studying fracture induction mechanisms under resonant excitation, improving the hydraulic fracturing performance of unconventional oil and gas reservoirs, and ultimately enhancing production and efficiency.

The embodiments of the present specification also provide an electronic device based on the method for rock hydraulic fracturing under resonance excitation described above. The device comprises a processor and a memory configured to store a program or instructions executable by the processor. When executed, the processor performs the following steps: acquiring excitation frequency time-series data applied to the perforated end face of the target rock sample, and strain time-series data of the remaining end faces other than the perforated end face, according to the simulated perforation diameter of the target rock sample; determining the resonance frequency of the target rock sample under the influence of the simulated perforation diameter based on the strain time-series data and the excitation frequency time-series data; determining the fracture initiation pressure and fracture initiation orientation of the target rock sample under the determined resonance frequency and a preset resonance excitation duration; and formulating a fracture induction scheme under resonance excitation based on the fracture initiation pressure and orientation, so as to perform hydraulic fracturing according to the fracture induction scheme.

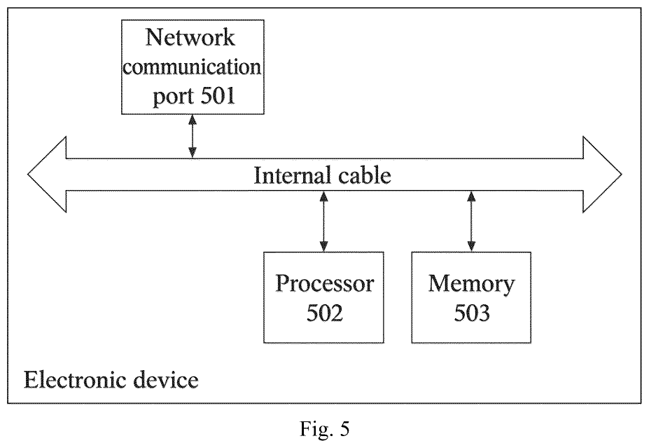

In order to perform the above instructions more accurately, as illustrated in FIG. 5, another embodiment of the electronic device is provided in this specification. The electronic device includes a network communication port (501), a processor (502), and a memory (503), which are interconnected through internal cables for data interaction.

The network communication port (501) is configured to acquire the excitation frequency time-series data applied to the perforated end face of the target rock sample and the strain time-series data of the remaining end faces, based on the simulated perforation diameter of the target rock sample.

The processor (502) is configured to determine the resonance frequency of the target rock sample under the influence of the simulated perforation diameter based on the strain time-series data and the excitation frequency time-series data; determine the fracture initiation pressure and orientation of the target rock sample under the resonance frequency and a preset resonance excitation duration; and formulate a fracture induction scheme under resonance excitation based on the determined fracture initiation pressure and orientation to carry out hydraulic fracturing accordingly.

The memory (503) is configured to store the corresponding instruction program.

In this embodiment, the network communication port (501) may be a virtual port bound to different communication protocols to send or receive different types of data. For instance, the port may support data communication over the web, file transfer protocol, or email protocols. Additionally, the network communication port may be a physical communication interface or chip, such as a wireless communication chip for mobile networks (such as GSM, CDMA), Wi-Fi chips, or Bluetooth chips.

In this embodiment, the processor (502) may be implemented in any appropriate manner. For example, the processor may be a microprocessor, or a processor in conjunction with a computer-readable medium that stores executable program code, including software or firmware. It may also include logic gates, switches, application-specific integrated circuits (ASICs), programmable logic controllers, or embedded microcontrollers.

The memory (503) may include multiple levels. In a digital system, any component capable of storing binary data can serve as memory. In integrated circuits, circuit components with storage capabilities such as RAM and FIFO are considered memory. In a physical system, devices such as memory modules or TF cards are also categorized as memory.

The embodiments of the present specification further provide a computer-readable storage medium based on the above-described rock hydraulic fracturing method under resonance excitation. The storage medium stores a computer program or instructions, which, when executed, perform the following: acquire the excitation frequency time-series data and the strain time-series data of the non-perforated end faces based on the simulated perforation diameter of the target rock sample; determine the resonance frequency of the target rock sample under the influence of the simulated perforation diameter; determine the fracture initiation pressure and fracture initiation orientation under the resonance frequency and preset resonance excitation duration; and formulate a fracture induction scheme under resonance excitation to carry out hydraulic fracturing.

In this embodiment, the computer-readable storage medium may include but is not limited to random access memory (RAM), read-only memory (ROM), cache memory, hard disk drives (HDDs), or memory cards. The memory can store computer program instructions. The network communication unit may conform to standard communication protocols and serve as an interface for network connectivity and communication.

The functions and effects of the program instructions stored on the computer-readable storage medium correspond to those described in the other embodiments and are not repeated here.

The present specification also provides a computer program product for implementing the above method of rock hydraulic fracturing under resonance excitation. The computer program product comprises a non-transitory computer-readable storage medium storing computer program instructions. The instructions are operable to cause a computer to perform the following: acquire the excitation frequency time-series data and the strain time-series data of the remaining end faces based on the simulated perforation diameter of the target rock sample; determine the resonance frequency of the target rock sample under the influence of the simulated perforation diameter; determine the fracture initiation pressure and orientation under the resonance frequency and preset resonance excitation duration; and formulate a fracture induction scheme under resonance excitation to carry out hydraulic fracturing.

Although the steps of the method are provided in a specific order in the embodiments or flowcharts, additional or fewer steps may be included using conventional or non-inventive methods. The step order presented in the embodiments is merely one example and does not represent the only possible execution order. The steps may be executed sequentially or in parallel, such as in multi-threaded or parallel processor environments, or distributed data processing environments.

Those skilled in the art will also understand that, in addition to implementing the controller as software-executable instructions, the same functions can also be realized through logical programming of the method steps using logic gates, switches, ASICs, programmable logic controllers, or embedded microcontrollers. Such a controller can be considered a hardware component, and the internal structures used to realize various functions can also be treated as structural components of the hardware.

The present specification may be described in the general context of computer-executable instructions executed by a computer, such as program modules. Generally, program modules include routines, programs, objects, components, data structures, or classes that perform specific tasks or implement specific data types. The present specification may also be practiced in distributed computing environments where tasks are performed by remote processing devices connected through a communication network. In distributed environments, program modules may be located in both local and remote computer storage media.

From the description of the above embodiments, it will be clear to those skilled in the art that the technical solutions provided in the present specification may be implemented in the form of software combined with a general hardware platform. Based on this understanding, the technical solutions of the present specification may essentially be embodied as a software product stored in a storage medium, such as ROM, RAM, magnetic disks, or optical disks. The software product includes instructions that enable a computing device (such as a personal computer, mobile terminal, server, or network device) to execute the method described in the various embodiments of the present specification.

The embodiments in the present specification are described in a progressive manner. Components that are the same or similar across the embodiments refer to one another. Each embodiment mainly describes the differences from other embodiments.

The present specification is applicable to a wide range of general-purpose or specialized computing environments and configurations, including but not limited to personal computers, server computers, handheld or portable devices, tablet devices, multiprocessor systems, microprocessor-based systems, set-top boxes, programmable electronic devices, network personal computers, minicomputers, mainframe computers, and distributed computing environments comprising the above systems or devices.

1. A method for rock hydraulic fracturing under resonant excitation, comprising:
obtaining excitation frequency time-series data applied at a perforated end face of a target rock sample, and strain time-series data from other end faces excluding the perforated end face, based on a simulated pore diameter of the target rock sample;
determining a resonant frequency of the target rock sample influenced by the simulated pore diameter from the excitation frequency time-series data based on the strain time-series data;
determining a fracture initiation pressure and a fracture initiation orientation of the target rock sample based on the resonant frequency and a preset resonant excitation duration;
formulating a fracture induction scheme based on the fracture initiation pressure and fracture initiation orientation;
and performing hydraulic fracturing according to the fracture induction scheme.

2. The method of claim 1, wherein the target rock sample is a rectangular specimen dried to constant weight, having one perforated end face with a simulated pore and five non-perforated end faces;
the method further comprising:
arranging a miniature ultrasonic vibration rod on the perforated end face;
arranging micro-resistance strain sensors respectively on the five non-perforated end faces;
heating the target rock sample to a target temperature;
injecting fracturing fluid into the simulated pore at a constant pressure;
wherein obtaining the excitation frequency time-series data and the strain time-series data comprises:
determining whether a stop-injection condition is met when the simulated pore diameter equals a preset diameter;
and if so, gradually increasing the excitation frequency of the vibration rod to acquire excitation frequency time-series data, and obtaining strain time-series data using the strain sensors.

3. The method of claim 2, wherein determining whether the stop-injection condition is met comprises:
obtaining transverse relaxation time-series data of the target rock sample to determine a water saturation level;
determining whether the water saturation reaches a preset target saturation;
and if so, stopping injection of the fracturing fluid.

4. The method of claim 1, wherein determining the resonant frequency comprises:
calculating an average of the strain time-series data from the five non-perforated end faces;
selecting a target average value that exceeds a preset threshold;
determining a time corresponding to the target average value as a resonant excitation time;
and identifying, from the excitation frequency time-series data, an excitation frequency corresponding to the resonant excitation time as the resonant frequency.

5. The method of claim 4, wherein:
when the simulated pore diameter equals a preset pore diameter, the resonant frequency is the frequency corresponding to a target water saturation;
and when the simulated pore diameter equals an inherent pore diameter, a target water saturation is determined corresponding to the resonant excitation time, and the resonant frequency is defined accordingly.

6. The method of claim 1, wherein determining the fracture initiation pressure comprises:
injecting fracturing fluid into the simulated pore at constant pressure;
when a preset resonant excitation time is reached, activating the ultrasonic vibration rod, setting its excitation frequency to the resonant frequency, and switching injection from constant pressure to constant flow;
continuing injection until the rock sample fractures;
acquiring pump pressure time-series data;
and determining, from the data, a target pressure sequence exceeding a preset threshold as the fracture initiation pressure.

7. The method of claim 1, wherein determining the fracture initiation orientation comprises:
after the rock sample fractures, performing computed tomography (CT) scanning to obtain a three-dimensional image;
and reconstructing the image to determine the fracture initiation orientation.

8. A resonant excitation-based hydraulic fracturing apparatus, comprising:
an acquisition module configured to obtain excitation frequency time-series data applied at a perforated end face of a target rock sample, and strain time-series data from other end faces excluding the perforated end face, based on a simulated pore diameter of the target rock sample;
a resonant frequency determination module configured to determine a resonant frequency of the target rock sample from the excitation frequency time-series data based on the strain time-series data;
a fracture initiation parameter determination module configured to determine a fracture initiation pressure and a fracture initiation orientation of the target rock sample under the resonant frequency and a preset excitation duration;
and a fracturing module configured to formulate a fracture induction scheme based on the fracture initiation pressure and orientation, and to perform hydraulic fracturing accordingly.

9. A computer device comprising a memory, a processor, and a computer program stored in the memory, wherein the processor executes the computer program to perform the method of any one of claims 1 to 7.

10. A computer-readable storage medium storing computer instructions which, when executed by a processor, cause the processor to perform the method of any one of claims 1 to 7.
